(19) United States
(12) Patent Application Publication
(10) Pub. No.: US 2026/0246701 A1
(43) Pub. Date: Aug. 20, 2026

(54) CONTROL SYSTEM

(71) Applicant: British Telecommunications Public Limited Company, London Greater London (GB)

(72) Inventors: Simon BEDDUS, London (GB); Claudia CRISTINA, London (GB); Fadi EL-MOUSSA, London Greater London (GB)

(21) Appl. No.: 19/159,524

(22) PCT Filed: Jan. 17, 2024
(86) PCT No.: PCT/EP2024/050989

§ 371 Date: Aug. 25, 2025

(30) Foreign Application Priority Data
Feb. 28, 2023 (EP) 23159163.7
Feb. 28, 2023 (GB) 2302930.9

(51) Int. Cl. H04L 41/0894; H04W 28/08

(52) U.S. Cl. CPC H04L 41/0894; H04W 28/0925

(57) ABSTRACT

A policy-based control system is provided for controlling distributed resources within a network. The system comprises a plurality of distributed policy providers. The plurality of distributed policy providers are arranged to collectively maintain a distributed ledger for storing contingency policies. The system further comprises a policy generator configured to: generate one or more contingency policies and provide the one or more contingency policies to at least one of the distributed policy providers for recording on the distributed ledger. Each of the contingency policies are for mitigating a respective issue that may be encountered and are associated with a respective trigger condition. The system further comprises a plurality of agents, each of the agents being associated with a respective subset of the distributed resources. Each of the agents are configured to: communicate with at least one of the distributed policy providers to obtain a contingency policy from the distributed ledger; and reconfigure one or more of the distributed resources associated with that agent in accordance with the contingency policy in response to the detection of the presence of the respective trigger condition for the contingency policy.

### FIELD OF THE INVENTION

The present invention relates to a control system. In particular, the present invention relates to a policy-based control system for controlling distributed resources within a network.

### BACKGROUND TO THE INVENTION

Policy-based control systems are used in computer networks to specify requirements and constraints on the resources within a network in order to meet a particular goal. They are typically specified in such a manner that allows them to be automatically enforced. That is to say, a policy can be automatically applied to a resource within a computer network to configure that resource such that the requirements and constraints of the policy are met.

There are a variety of different types of resources within a computer network to which a policy might be applied, including compute, storage and/or network resources. One common type of policy that can be applied are security policies that specify security requirements and constraints. For example, a security policy applied to a firewall might result in the generation of a set of firewall rules that satisfy the specified requirements and constraints. However, there are a wide range of other types of policy that can also (or alternatively) be applied, including, for example, more general orchestration policies that configure the resources in the computer network so as to implement a service.

Orchestration systems are increasingly being used to enable automatic configuration, coordinating and management of the resources required to deliver services to end users.

Such systems may, for example, configure various network, compute and storage resources so as to implement the service. In order to configure the resources, an orchestration system will typically generate a set of policies that when applied to an appropriate set of resource results in the resources being configured so as to implement the service.

### SUMMARY OF THE INVENTION

As computer networks grow in size, the difficulty of managing resources within a network increases. This difficulty extends to the ability to address issues that arise within the network. For example, as service complexity increases, such as through the inclusion of many different types of resource residing in many different locations (e.g. in the cloud, within the core network and/or at the network edge)—which may also include less reliable and/or more constrained resources (as can be the case in some modern IoT systems)—the likelihood of a service encountering issues increases. Another source of issues that may arise in a network is the ever-increasing threats faced from potential attackers looking to intentional compromise a network's resources and any services that rely upon them. Accordingly, it would be desirable to improve the ability of a network to manage its resources in the face of such issues.

In a first aspect of the invention, there is provided a policy-based control system for controlling distributed resources within a network, the system comprising: a plurality of distributed policy providers, the plurality of distributed policy providers being arranged to collectively maintain a distributed ledger for storing contingency policies; a policy generator configured to: generate one or more contingency policies, each contingency policy for mitigating a respective issue that may be encountered and being associated with a respective trigger condition; and provide the one or more contingency policies to at least one of the distributed policy providers for recording on the distributed ledger; and a plurality of agents, each of the agents being associated with a respective subset of the distributed resources and being configured to: communicate with at least one of the distributed policy providers to obtain a contingency policy from the distributed ledger; and reconfigure one or more of the distributed resources associated with that agent in accordance with the contingency policy in response to the detection of the presence of the respective trigger condition for the contingency policy.

The contingency policy may specify one or more resource-specific policies, each of the one or more resource-specific policies for configuring a respective type of resource, wherein the reconfiguration of the distributed resources by an agent comprises applying each of the resource-specific policies to distributed resources of that type that are associated with the agent.

The system may be an orchestration system and the policies relate to the control of distributed resources involved in the implementation of a service orchestrated by the orchestration system. The contingency policy may specify one or more service-reconfiguration policies, each of the one or more service-reconfiguration policies for causing a change to the implementation of at least a portion of the service using a different configuration of distributed resources.

The policy generator may be further configured to provide the one or more contingency policies to the central policy provider and the agents may be further configured to: determine whether communication with the central policy provider is possible; and communicate with the central policy provider to retrieve a contingency policy in response to determining that communication with the central policy provider is possible, wherein the communication with the at least one of the distributed policy providers may be performed in response to a determination that communication with the central server is not possible.

The policy generator may be configured to generate a plurality of contingency policies, each policy addressing a respective one of a plurality of types of issue that may be encountered and the distributed policy providers may be arranged to collectively maintain a plurality of distributed ledgers for storing contingency policies, each of the distributed ledgers being associated with a respective type of issue. The types of issue may comprise one or more, or all of: a distributed denial of service attack; a malware infection; a networking issue; and a service orchestration issue.

The distributed policy providers may be further arranged to collectively maintain a further distributed ledger for storing an indication of which of the contingency policies have been applied and the agents may be configured to provide an indication to the distributed policy providers when a contingency policy has been applied for storage in the further distributed ledger. The indication may comprise an indication of which of the distributed resources associated with the agent were affected by the application of the contingency policy.

As a result of the distribution of contingency policies via distributed policy providers within the network, the ability for the network to recover from encountered issues can be improved. In particular, even where centralised control of the resources is difficult or impossible, such as in the case of a failure or attack affecting the centralised control system (e.g. a distributed denial of service attack or a network failure), the distributed resources can still be managed via the contingency policies that are made available to agents local to the resources via the distributed policy providers. Accordingly, the resources can be reconfigured to address the issue (or issues) that has been encountered, helping to mitigate the impact of the issue on the network and any services orchestrated within it. Of course, even where centralised control of the resources is possible, the availability of the contingency policies from the distributed policy providers can help to reduce the burden on the centralised control system and increase the speed of responding to issues as they arise. Furthermore, the present invention provides a decentralised mechanism of policy-based control, that can also enable the sharing of policies to mitigate issues directly between the agents within the system. For example, with the rise of automated response generation mechanisms, any agent within the system detecting an issue for which no contingency policy exists may generate its own response to the issue and share a contingency policy detailing that response to allow other agents that later experience the same issue to address it without needing to repeat the analysis.

### BRIEF DESCRIPTION OF THE FIGURES

Embodiments of the present invention will now be described by way of example only, with reference to the accompanying drawings, in which:

FIG. 1 is a block diagram of a computer system suitable for the operation of embodiments of the present invention.

FIG. 2 is a block diagram of an exemplary policy-based control system 200 according to embodiments of the invention.

### DETAILED DESCRIPTION OF EMBODIMENTS

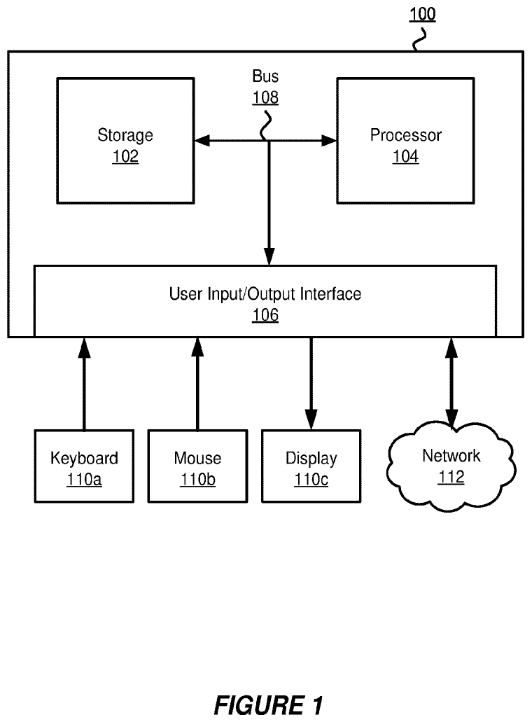

FIG. 1 is a block diagram of a computer system 100 suitable for the operation of embodiments of the present invention. The system 100 comprises: a storage 102, a processor 104 and an input/output (I/O) interface 106, which are all communicatively linked over one or more communication buses 108.

The storage (or storage medium or memory) 102 can be any volatile read/write storage device such as a random access memory (RAM) or a non-volatile storage device such as a hard disk drive, magnetic disc, optical disc, ROM and so on. The storage 102 can be formed as a hierarchy of a plurality of different storage devices, including both volatile and non-volatile storage devices, with the different storage devices in the hierarchy providing differing capacities and response times, as is well known in the art.

The processor 104 may be any processing unit, such as a central processing unit (CPU), which is suitable for executing one or more computer programs (or software or instructions or code). These computer programs may be stored in the storage 102. During operation of the system, the computer programs may be provided from the storage 102 to the processor 104 via the one or more buses 108 for execution. One or more of the stored computer programs, when executed by the processor 104, cause the processor 104 to carry out a method according to an embodiment of the invention, as discussed below (and accordingly configure the system 100 to be a system 100 according to an embodiment of the invention). The input/output (I/O) interface 106 provides interfaces to devices 110 for the input or output of data, or for both the input and output of data. The devices 110 may include user input interfaces, such as a keyboard 110a or mouse 110b as well as user output interfaces such as a display 110c. Other devices, such a touch screen monitor (not shown) may provide means for both inputting and outputting data. The input/output (I/O) interface 106 may additionally or alternatively enable the computer system 100 to communicate with other computer systems via one or more networks 112. It will be appreciated that there are many different types of I/O interface that may be used with computer system 100 and that, in some cases, computer system 100 may include more than one I/O interface. Furthermore, there are many different types of device 100 that may be used with computer system 100. The devices 110 that interface with the computer system 100 may vary considerably depending on the nature of the computer system 100 and may include devices not explicitly mentioned above, as would be apparent to the skilled person. For example, in some cases, computer system 100 may be a server without any connected user input/output devices. Such a server may receive data via a network 112, carry out processing according to the received data and provide the results of the processing via a network 112.

It will be appreciated that the architecture of the system 100 illustrated in FIG. 1 and described above is merely exemplary and that other computer systems 100 with different architectures (such as those having fewer components, additional components and/or alternative components to those shown in FIG. 1) may be used in embodiments of the invention. As examples, the computer system 100 could comprise one or more of: a personal computer; a laptop; a tablet; a mobile telephone (or smartphone); a television set (or set top box); a games console; an augmented/virtual reality headset; a server; or indeed any other computing device with sufficient computing resources to carry out a method according to embodiments of this invention.

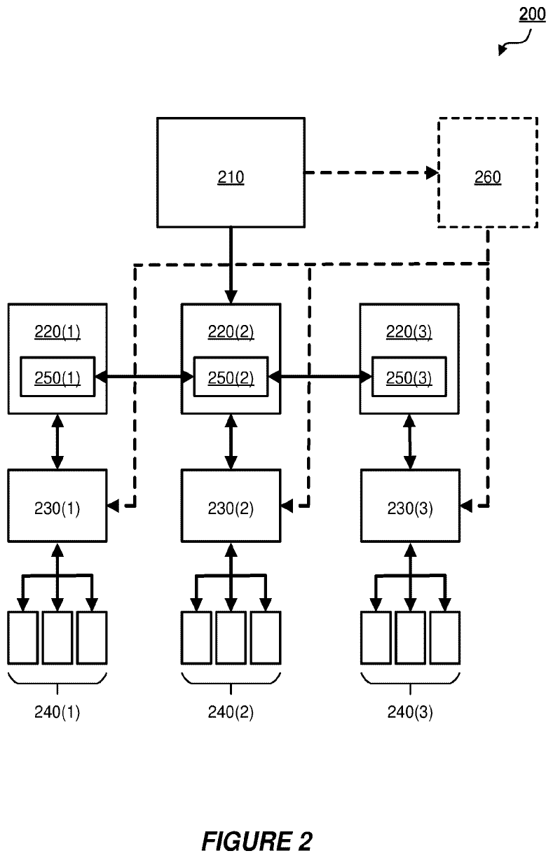

FIG. 2 is a block diagram of an exemplary policy-based control system 200 according to embodiments of the invention. The system 200 comprises a policy generator 210, a plurality of distributed policy providers 220, and a plurality of agents 230. Each of these components of system 200 may be implemented using any suitable technique including, for example, the use of software to configure a general purpose computer system, such as the computer system 100 described in relation to FIG. 1, to operate in the required manner.

The components of the system 200 (that is to say, the policy generator 210, the distributed policy providers 220 and the agents 230) are generally configured so as to allow the control of distributed resources 240 within a network in which the system 200 is operating, as described in more detail below. This control is effected through the use of policies. Specifically, the system 200 allows for one or more contingency policies to be defined and distributed through the system 200 for use in controlling the resources 240 whenever specific issues are encountered.

In some cases, the system 200 may be a service orchestration system that operates to orchestrate (or implement) a particular service using the distributed resources 240 under its control. Accordingly, in such cases, the system 200 may additionally orchestrate an initial service implementation using policies that are applied to the distributed resources 240 during orchestration to configure them according to an initial design and may additionally specify contingency policies to allow that service implementation to be adapted in order to mitigate issues that may be encountered during its operation.

The policy generator 210 is configured to generate one or more contingency policies for controlling at least some of the resources 240 whenever a specific issue is encountered. Each contingency policy is associated with a respective issue that it is intended to mitigate as well as a trigger condition that indicates the presence of that issue.

The contingency policy may, in some cases, specify one or more resource-specific policies. Each of the resource-specific policies in a contingency policy being intended for a specific type of resource. These resource-specific policies may also, in some cases, specify certain properties of the resource to which it is to be applied in addition to the type of resource. For example, a resource-specific policy may be intended to be applied to resources of a specific type that are configured in a specific way (such as those that are running a specific item of software).

Additionally or alternatively, the contingency policy may specify one or more service-reconfiguration policies. In particular, where the system 200 is an orchestration system, the service-reconfiguration policies may specify a change to the implementation of at least a portion of the service. For example, the orchestration system may cause different resources 250 to be used in implementing that portion of the service. Similarly, the orchestration system may cause the existing resources 250 that are currently used to implement that portion of the service to be reconfigured in some way that mitigates the specific issue.

It is generally anticipated that the policy generator 210 is part of a centralised control mechanism for the resources 240, separate from the agents 230 and distributed policy providers 220. However, in some cases, the agents 230 (or distributed policy providers 220) themselves may generate policies and distribute them via the distributed policy providers 220. For example, in some cases, when faced with an issue, an agent 230 may be configured to determine an appropriate response for handling that issue. That agent 230 may then generate and publish a contingency policy to convey the detected issue and determined response to the other agents 230. This can enable the other agents 230 to more efficiently deal with that same issue should it arise (i.e. by simply applying the shared policy without first needing to carry out the processing themselves to determine what the appropriate response should be). Indeed, in some cases, the distributed ledger 250 may contain contingencies policies generated by multiple different entities. For example, in such cases, some contingency policies may originate from a central policy generator, while others may have been generated by one or more of the agents 230.

In any case, having generated one or more contingency policies, the policy generator 210 is further configured to provide those contingency policies to at least one of the distributed policy providers 220 to make them more widely available throughout the system 200.

The distributed policy providers 220 are arranged to collectively maintain a distributed ledger 250 for storing contingency policies received from the policy generator 210. As will be familiar to those skilled in the art, in doing so, each of the distributed policy providers 220 maintains their own local copy of the distributed ledger 250 from which they can access the data recorded to the distributed ledger 250. Any of the distributed policy providers 250 can write data to the distributed ledger 250 by generating an update that is then distributed to the other distributed policy providers 250. Upon receipt of the update, the distributed policy providers then update their local copy of the distributed ledger 250 accordingly. In the exemplary system 200 shown in FIG. 2, for example, a first distributed policy provider 220(1) maintains its own local copy of the distributed ledger 250(1), a second distributed policy provider 220(2) maintains its own local copy of the distributed ledger 250(2) and a third distributed policy provider 220(3) maintains its own local copy of the distributed ledger 250(3). Accordingly, in this example, there are three separate copies of the distributed ledger that are maintained. However, it will be appreciated that any suitable number of distributed policy providers 220 may be used in the system 200 and as a result any number of copies of the distributed ledger (one per distributed policy provider 220) may also be present. Furthermore, any suitable form of distributed ledger technology, such as a blockchain, may be used to implement the distributed ledger 250.

The distributed policy providers 220 are distributed throughout the network in which the system 200 operates. That is to say, they are generally dispersed through the network (or networks) within which the system 200 is operating rather than being substantially collocated. Accordingly, the distributed policy providers 220 are generally closer to the agents 230 and their associated resources 240 (at least in terms of network connectivity) than any centralised control systems are. The dispersal of the distributed policy providers 220 throughout the network(s) reduces the likelihood of disruption between the agents 230 and the distributed policy providers 220.

As will be appreciated by those familiar with distributed ledgers, when an update to the distributed ledger 250 is published by any of the distributed policy providers 220, such as through the creation of a new block, it may be checked and verified by (at least some of) the other distributed policy providers 220 before it is added to their copy of the distributed ledger 250. For example, when creating a new block to add to the blockchain, a distributed ledger waits a set period before creating the block and then signs it with its private key before publishing it to the blockchain network (e.g. the other distributed policy providers 220). The block includes attributes about the contingency policy, such as the trigger criteria and details of the intervention (i.e. actions) to be taken to mitigate an issue, as will as hash data for verifying the integrity of the block and its association to a preceding block of the blockchain and a signature of the block using a private key belonging to the distributed policy provider 220. After publishing it to the blockchain network, one or more of the other distributed policy providers 220 may check the block before publishing an approval of the addition of the block to the blockchain. For example, the one or more other distributed policy providers 220 may check that the block was published by an authorised distributed policy provider 220 (e.g. using the signature of the block and the known public keys of the authorised policy providers 220). They may also check the integrity of the data using the hash data. Once all necessary approvals have been received, the new block is added to the blockchain, thereby adding the new contingency policy to the distributed ledger 250.

In some cases, before attempting to add a contingency policy to the distributed ledger 250, the distributed policy providers 220 may check that it has not already been written (or is about to be written) by another of the distributed policy providers 220. For example, the distributed policy providers 220 may check that no policy having the same identifier as the received contingency policy is already recorded on the distributed ledger 250. This can be useful, for example, in those cases where the policy generator 210 may send the contingency policies to more than one of the distributed policy providers 220 (e.g. to improve the chances of successfully distributing a contingency policy via the distributed policy providers 220 in case one of the distributed policy providers 220 fails to receive and/or record the contingency policy to the distributed ledger 250).

In some cases, the distributed policy providers 220 may collectively maintain a plurality of distributed ledgers 250 for storing contingency policies. Some of of the distributed ledgers 250 may be dedicated to storing contingency policies relating to a specific type of issue.

Indeed, in some cases, a separate distributed ledger 250 may be maintained for each type of issue for which contingency policies are provided. For example, separate distributed ledgers 250 may be maintained for different types of security (e.g. malware or denial of service attacks), networking and/or service orchestration issues. In such cases, the distributed policy providers 220 may determine which of the distributed ledgers 250 a contingency policy should be written to and retrieved from based on the type of issue that the contingency policy addresses.

The plurality of agents 230 are configured to control the resources 240 within the system based on policies received from the other components of the system 200. Each of the agents 230 is associated with a respective subset 240 of the distributed resources 240 which that agent is responsible for controlling (i.e. by configuring or reconfiguring them in accordance with one or more policies). In the exemplary system 200 illustrated in FIG. 2, for example, a first agent 230(1) is in control of a first subset 240(1) of the resources, a second agent 230(2) is in control of a second subset 240(2) of the resources and a third agent 230(3) is in control of a third subset 240(3) of the resources. However, although the exemplary system 200 is shown having three agents 230 present, it will be appreciated that any suitable number of agents 230 may be used instead. It is also noted that the subsets of resources 240(1), 240(2) and 240(3) associated with each agent 230 can differ in size and/or type of resources from one another (e.g. the resources 240 do not need to be evenly distributed between the agents 230).

The agents 230 may be implemented in software installed either on an existing computer system 100 that is being used for another purpose or an a dedicated computer system 100. Ideally, the agents are located close to the resources 240 that it is responsible for managing. This can improve the speed of communicating with those resources 240 as well as improving the reliability of communication. In some cases, the agents 230 may communicate with one or more orchestration systems (not shown) in order to control the resources 240. In such cases, the agents 230 may be deployed to the same computer system 100 on which one of the orchestration systems is deployed (though this need not necessarily be the case). In other cases, the agents 230 may themselves function as an orchestration system by controlling the resources directly.

The agents 230 are configured to communicate with at least one of the distributed policy providers 220 to obtain one or more contingency policies that have been generated by the policy generator 210 and distributed amongst the distributed policy providers 220 via the distributed ledger 250 as described above. In the exemplary system 200 illustrated in FIG. 2, for example, the first agent 230(1) is in communication with the first distributed policy provider 220(1), the second agent 230(2) is in communication with the second distributed policy provider 220(2) and the third agent 230(3) is in communication with the third distributed policy provider 220(3). Again, it will be appreciated that this is merely exemplary. There is no need for the same numbers of distributed policy providers 220 and agents 230 to be present in the systems 200, nor is there any need for them to be arranged in a one-to-one relationship, as illustrated in FIG. 2. For example, in some cases, multiple agents 230 may communicate with the same distributed policy provider 220 in order to receive the contingency policies.

As discussed above, each of the contingency policies is associated with a respective trigger condition for applying that contingency policy. When the trigger condition for a policy is detected as being present for the resources 240 associated with a particular agent 230, that agent 230 causes the resources 240 to be reconfigured in accordance with the contingency policy. In some cases, this may be achieved by supplying the contingency policy (or a relevant portion of the contingency policy) to each of the resources 240 (or to an orchestration system controlling those resources 240) to which the policy needs to be applied. Those resources 240 may then reconfigure themselves accordingly. In other cases, the agent 240 itself may interpret the policy and generate an appropriate set of commands to reconfigure the resources 240.

The contingency policies may be filtered such that only those contingency policies that are applicable to each agent 230 (that is to say, those which relate to resources 240 under that agent's control) are processed by each agent 230. The trigger conditions associated with any contingency policies that are not applicable to an agent may therefore not be monitored by that agent 230. For example, a contingency policy that relates to a specific application may be ignored for those agents who do not have any resources running that application. Accordingly the presence of the trigger condition for such a policy may not be monitored for those agents since the policy is not applicable. In order to determine whether a policy is applicable, the agent 230 may gather various configuration and performance information about the resources 240 (e.g. networks and systems) under its control. For example, the agent 230 may use any number of probes into its resources to collect attributes such as: application processes, resources consumed, network connections (ports and bridges), popular applications, the presence of virtual infrastructure managers (such as hypervisors or containerisation services) or existing orchestration systems, and so on. The actions of the policy may then be compared to the configuration and performance information for an agent 230 to determine whether the policy is applicable to that agent 230 (i.e. whether the policy would cause reconfiguration of any of the resources under that agent's control were it to be applied). This filtering may be performed either by the agents 230 themselves or by the distributed resource providers 220. Where the filtering is performed by the distributed resource providers 220, the agents 230 may make the collected configuration and performance information for the resources 240 under their control available to allow the distributed resource providers 220 to make the determination as to the relevance of the contingency policies to each agent 230 on their behalf.

The provision of the contingency policies to the agents 230 can be performed in either a proactive or a reactive manner. That is to say, the contingency policies may be provided to the agents 230 as soon as (or shortly after) they are communicated to the distributed resource providers 220. This proactive approach means that the agents 230 can monitor for the trigger conditions of each policy and apply the policy (if appropriate) once those trigger conditions have been detected as being present. Alternatively, the agent 230 may request contingency policies from the distributed policy providers 220 reactively in response to detecting an issue. In such cases, the agent 230 may provide details of the issue that has been detected to the distributed policy providers 220 to allow the distributed policy providers 220 to select one or more contingency policies from those available that address that issue (though this isn't strictly necessary and in other cases, the distributed policy providers 220 may simply provide all contingency policies that are applicable to an agent 230 to allow the agent 230 to select one that addresses the issue it is experiencing).

The detection of the trigger condition (and, where the contingency policies are reactively obtained, of the issue to prompt retrieval of a contingency policy) can be based on any suitable data. For example, the detection may be based on various configuration and performance information gathered from the resources 240 associated with an agent 230 (as discussed above in relation to the optional filtering of contingency policies for an agent 230). However, other data sources may be used in addition, or as an alternative to, such data. For example, information relating to security events may be obtained from security appliances within the network that the resources 230 are operating. This information may allow the detection of various security issues, such as the presence of Distributed Denial of Service (DDOS) attacks or malware. As another example, data relating to network traffic may be obtained from networking appliances within the network that the resources 230 are operating in to allow the detection of various networking issues, such as a loss of connectivity within the network..

Having obtained a contingency policy from the distributed policy providers 220 and detected the respective trigger condition for that policy in respect of the resources 240 associated with that agent 230, the agent 230 applies the contingency policy to the resources, thereby mitigating the issue.

Although the agents 230 and distributed policy providers 220 have been shown as separate entities in the exemplary system 200 illustrated in FIG. 2, it will be appreciated that in some cases, the functionality of at least some of the agents 230 may be combined with the functionality of a respective one of the distributed policy providers 220 such that they are conceptually provided by a single entity.

In some cases, the system 200 may further comprise a central policy provider 260. In such cases, the agents 230 may be configured to obtain the contingency policies from the central policy provider 260 in preference to the distributed policy providers 220. That is to say, in such cases, the distributed policy providers 220 may function as a backup policy distribution mechanism to allow retrieval of contingency policies by the agents 230 should the central policy provider 260 be unavailable. Accordingly, the policy generator 210 may be configured to provide the one or more contingency policies that are generated to the central policy provider 260 in addition to the distributed policy providers 220. The agents 230 may then be configured to determine whether communication with the central policy provider 260 is possible before determining where the contingency policies should be retrieved from. If an agent 230 can communicate central policy provider 260, then a contingency policy can be retrieved from the central policy provider 260; otherwise, the agents 230 retrieve contingency policies from the distributed policy providers 220.

In some cases, the distributed policy providers may also maintain a further (or additional) distributed ledger for the purpose of recording where each of the contingency policies has been applied. This further distributed ledger allows information about the current state of the resources in the system 200 to be made available throughout the system. For example, the agents 230 may be configured to provide an indication to the distributed policy providers 220 whenever a contingency policy has been successfully applied to resources 240 under their control. Accordingly, when receiving a notification from an agent 230 that a contingency policy has been applied by that agent 230 to resources 240 under that agent's control, the distributed policy provider 220 may then record that that contingency policy has been applied by that agent 230. In some cases, the fact that the policy has been applied may be all that is required. However, in other cases, further information about the specific resources 240 that the policy has been applied to (possibly together with other information about the new configuration of those resources) may be provided by the agent 230 and recorded in the further distributed ledger. Having written the data to the further distributed ledger, the data will be disseminated to other copies of the further distributed ledger that are maintained by the other distributed policy providers 220 (in a similar manner to that already discussed and as will be familiar to those skilled in the art). One or more of the distributed policy providers 220 may then make the data about the application of the contingency policies within the system more widely available, for example, to the policy generator 210 or central policy provider 260. Accordingly, the use of this further distributed ledger in this way enables the current state of the system 200 to be known even where (for example) communication with a centralised controller is interrupted due to a current issue. This can be useful, for example, to allow additional mitigating actions to be orchestrated centrally, as well as to allow centralised control of the system to be recovered more efficiently once the issue has been mitigated.

The operation of the system 200 will now be further discussed, by way of an example. In this example, the system 200 may be used to maintain a collection of contingency policies which aim to resolve different network issues that might arise, such as congestion, loss of connectivity and/or network device failures, in respect of a service that has been orchestrated using the resources 240. For example, one such policy may be a video streaming traffic throttling policy that instructs a certain type of video application to throttle its traffic in response to detecting network congestion. Such a policy may be generated by the policy generator 210 and distributed to the distributed policy providers 220 to store on the distributed ledger 250. The distributed policy providers 220 may determine which agents 230 the video streaming traffic throttling policy is applicable to (e.g. those agents associated with resources that are running that specific video application) and provide the policy to those agents. Those agents 230 may then monitor for the presence of the trigger condition for the video streamlining traffic throttling policy (e.g. the presence of network congestion) and, in response to detecting the trigger condition, apply the policy to the resources that are running that specific video application, thereby resulting in the throttling of traffic from the video application helping to mitigate the network congestion.

Insofar as embodiments of the invention described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present invention. The computer program may be embodied as source code or undergo compilation for implementation on a processing device, apparatus or system or may be embodied as object code, for example. Suitably, the computer program is stored on a carrier medium in machine or device readable form, for example in solid-state memory, magnetic memory such as disk or tape, optically or magneto-optically readable memory such as compact disk or digital versatile disk etc., and the processing device utilises the program or a part thereof to configure it for operation. The computer program may be supplied from a remote source embodied in a communications medium such as an electronic signal, radio frequency carrier wave or optical carrier wave. Such carrier media are also envisaged as aspects of the present invention. It will be understood by those skilled in the art that, although the present invention has been described in relation to the above-described example embodiments, the invention is not limited thereto and that there are many possible variations and modifications which fall within the scope of the invention. The scope of the present invention includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A policy-based control system for controlling distributed resources within a network, the system comprising:
a plurality of distributed policy providers, the plurality of distributed policy providers being arranged to collectively maintain a distributed ledger for storing contingency policies;
a policy generator configured to:
generate one or more contingency policies, each contingency policy for mitigating a respective issue that may be encountered and being associated with a respective trigger condition; and
provide the one or more contingency policies to at least one of the distributed policy providers for recording on the distributed ledger; and
a plurality of agents, each of the agents being associated with a respective subset of the distributed resources and being configured to:
communicate with at least one of the distributed policy providers to obtain a contingency policy from the distributed ledger; and
reconfigure one or more of the distributed resources associated with that agent in accordance with the contingency policy in response to the detection of the presence of the respective trigger condition for the contingency policy.

2. The system of claim 1, wherein the contingency policy specifies one or more resource-specific policies, each of the one or more resource-specific policies for configuring a respective type of resource, wherein the reconfiguration of the distributed resources by an agent comprises applying each of the resource-specific policies to distributed resources of that type that are associated with the agent.

3. The system of claim 1, wherein the system is an orchestration system and the policies relate to the control of distributed resources involved in the implementation of a service orchestrated by the orchestration system.

4. The system of claim 3, wherein the contingency policy specifies one or more service-reconfiguration policies, each of the one or more service-reconfiguration policies for causing a change to the implementation of at least a portion of the service using a different configuration of distributed resources.

5. The system of claim 1, wherein:
the policy generator is further configured to provide the one or more contingency policies to the central policy provider; and
the agents are further configured to:
determine whether communication with the central policy provider is possible; and
communicate with the central policy provider to retrieve a contingency policy in response to determining that communication with the central policy provider is possible,
wherein the communication with the at least one of the distributed policy providers is performed in response to a determination that communication with the central server is not possible.

6. The system according to claim 1, wherein:
the policy generator is configured to generate a plurality of contingency policies, each policy addressing a respective one of a plurality of types of issue that may be encountered; and
the distributed policy providers are arranged to collectively maintain a plurality of distributed ledgers for storing contingency policies, each of the distributed ledgers being associated with a respective type of issue.

7. The system of claim 6, wherein the types of issue comprise one or more, or all of:
a distributed denial of service attack;
a malware infection;
a networking issue; and
a service orchestration issue.

8. The system of claim 1, wherein:
the distributed policy providers are further arranged to collectively maintain a further distributed ledger for storing an indication of which of the contingency policies have been applied; and
the agents are configured to provide an indication to the distributed policy providers when a contingency policy has been applied for storage in the further distributed ledger.

9. The system of claim 8, wherein the indication comprises an indication of which of the distributed resources associated with the agent were affected by the application of the contingency policy.
